(19) United States
(12) Patent Application Publication
(10) Pub. No.: US 2018/0152500 A1
(43) Pub. Date: May 31, 2018

(54) METHOD FOR ATTACHING HASH-TAG USING IMAGE RECOGNITION PROCESS AND SOFTWARE DISTRIBUTING SERVER STORING SOFTWARE FOR THE SAME METHOD

(71) Applicant: Indie CF, Inc., Seoul (KR)

(72) Inventor: Joung Hwa PARK, Seoul (KR)

(73) Assignee: Indie CF, Inc., Seoul (KR)

(21) Appl. No.: 15/385,163

(22) Filed: Dec. 20, 2016

(30) Foreign Application Priority Data
Nov. 25, 2016 (KR) 10-2016-0158308

(51) Int. Cl. H04L 29/08; G06F 17/30; H04L 12/58; G06T 7/70; G06K 9/46

(52) U.S. Cl. CPC H04L 67/10; G06F 17/30858; G06K 9/4604; H04L 51/32; G06T 7/70; H04L 67/306

(57) ABSTRACT

A method for attaching a hash tag with image recognition, and a software distributing server recording therein software for performing the method, are provided. When a user creates his or her own post with his or her video to upload to a webpage of social media, the terminal may automatically extract words to be used as the hash tags from the video and insert the extracted words. Because name of object acquired by object recognition on image, or word extracted from the subtitle inserted into the image content are used as the hash tag, the possibility that the image content is searched with the hash tag search greatly increases.

### TECHNICAL FIELD

The present disclosure relates to a method for setting hash tag for the purpose of on-line distribution of image contents, and more particularly, to a method for performing object recognition for an image of interest and automatically attaching an associated hash tag, and a software distributing server storing therein software for performing the same method.

### BACKGROUND ART

‘Hash tag’ refers to a type of identification code used in the social network service, and so on, which allows users to write a specific word after hash symbol # and collect posts related to that word.

The hash tag has been first introduced in 1970. Although the hash tags back then had not exactly the same functions as today, the hash tags were used in programming code, and so on. Then with the use of social media (or social network service) such as Twitter, Facebook, Instagram, and so on, hash tags have been widely used by general public for its role described above. That is, the hash tag is used in such a manner that it is included in the post of author's writing or image to be uploaded on Facebook, and so on.

Hash tag is currently widely used as one of the advertisement methods with the use of social media. This way of advertising involves the process in which posts using company trademark or product name as a hash tag is registered, and then customers interested in the content of the post re-post the corresponding content, or participate in a new event derived therefrom. For example, hash tags are also widely used in the advertisement field because one can collect posts attached with the same hash tag to monitor results of advertising promotional activities or events.

Meanwhile, advertising market is a complex market where advertisers, media companies (or media), and advertising companies produce, distribute, and consume goods (i.e., advertisements) within an interconnected distribution structure. All participants of the economic activities, which provide services or supply goods, use advertising market to utilize the advertisement as a means of marketing that can make its own goods better known to the customers.

In terms of the form, the advertisement in an image form can provide relatively greater advertisement effect than other forms of advertisements, since it can instantly convey the advertised subject by way of appealing to visual and audio senses, and also conveying a story within a relatively brief time. The image advertisement has varied degrees of exposures or effects, depending on a medium through which the image advertisement is reproduced. As is well known, the public medium like TV is most widely used and also provides sufficient effect. However, considering cost which is quite expensive, only a limited number of advertisers can use this medium. In the same sense, advertisements utilizing advertisement platform of internet portal sites or the social media are advantageous in view of economic cost, but with the offset of the effect.

Because advertisements using posts distributed through social media are not the platform devoted to advertisements, in order to provide advertisement function, more efforts and additional means are necessary, such as using hash tag, for one example.

Meanwhile, when attaching hash tag to the image contents uploaded on social media, a user is not required to comply with certain limitations such as he or she should use a word summarizing the content of the image, or the like. That is, virtually anything can serve as hash tag, and this particular feature can sometimes bring about unexpected advertisement effect.

### RELATED ART

Korean Registered Patent No. 1657582 (title: System and method for extracting hash tag from goods image using web)

Korean Registered Patent No. 1657582 relates to extracting a hash tag, by comparing characteristic data extracted from an image of a product on sale with pre-stored characteristic data of a reference image and selecting a hash tag of the reference image, which has a similarity equal to or greater than a predetermined similarity with the image of the product on sale.

This related method has difficulty of applying the described method for use with a video such as an advertisement video, considering that the hash tag is extracted from an image, and not a video. For example, the related method finds a reference image having a similarly in view of the entire image to extract a corresponding hash tag, and it is not easy to extract a video having such similarity in view of the video. Further, without separate management of videos preset with hash tags, applications will be difficult.

### DISCLOSURE OF INVENTION

### Technical Problem

An object of the present disclosure is to solve the problems mentioned above, and accordingly, it is an object of the present disclosure to provide a method for setting a hash tag for the purpose of internet distribution of image contents, i.e., to provide a method for performing object recognition and so on with respect to an image of interest and automatically attaching an associated hash tag, and a software distributing server storing software for implementing the method.

### Solution to Problem

According to the present disclosure, a method for automatically attaching a hash tag is provided, which may be implemented at a terminal capable of generating a post to post a video on a website of a social media. The method according to an exemplary embodiment includes: at a post generator, displaying a post generating screen to generate the post for the video; at an image processor, recognizing at least one object from each of image frames of the video inserted into the post generating screen, and extracting a name of one object from database; at the image processor, extracting at least one noun from a subtitle inserted into the video; and at the post generator, inserting the name of at least one object and the at least one noun as a hash tag and complete the post.

According to some exemplary embodiments, the method may further include at the post generator, inputting a reference hash tag from a user; and at the post generator, using a preset associated algorithm to select a word associated with the reference hash tag from among the name of at least one object and the at least one noun. In this case, the completing the post may include attaching the selected word as the hash tag, instead of the name of at least one object and the at least one noun. One of the methods for inputting the reference hash tag may include inputting, through the post generating screen and from the user, a message to be included in the post, and then using a noun that is most frequently repeated among the at least one noun included in the message, as the reference hash tag.

According to another exemplary embodiment, when the extracted object is a face of a person, the database may preferably be a server of the social media website.

According to another exemplary embodiment, the method may further include, at the post generator, selecting, among the name of at least one object and the at least one noun, a preset number of words in an order of higher rate of repetition. In this case, the completing the post may include attaching the selected words as the hash tag.

Furthermore, when the extracted object is a face of a person, the completing the post may include attaching a name of the person extracted from the database, along with the selected words. In this example, the database may be a server of the social media website.

The present disclosure is applicable to a software distributing server that records therein software for performing operations of the image processor and the post generator with the method for setting a hash tag described above. In this case, the software distributing server stores and manages the software on a computer-readable storage medium, and the terminal may access the software distributing server via the internet to download the software.

### Advantageous Effects of Invention

According to various exemplary embodiments, when a user attempts to create a post with his or her own video to upload to a webpage of social media, a word to be used as a hash tag can be automatically extracted from the video and attached.

Because the name of object acquired with object recognition on an image, or word extracted from the subtitle inserted into the image content is used as the hash tag, the possibility that the image content will be searched by the hash tag search greatly increases. Because the possibility that a specific video will be searched on an open platform named ‘social media’ by the user's general search keywords, the advertisement effect also greatly increases when the corresponding video is an advertisement image.

### BRIEF DESCRIPTION OF DRAWINGS

FIG. 1 is a diagram of a system including a terminal for implementing a method according to an exemplary embodiment of the present disclosure.

FIG. 2 is a diagram illustrating an example of a post generating screen displayed on a terminal according to an exemplary embodiment of the present disclosure.

FIG. 3 is a flowchart provided to explain a method for generating a hash tag according to an exemplary embodiment of the present disclosure.

### MODE FOR THE INVENTION

Hereinbelow, exemplary embodiments of the present disclosure will be described in detail with reference to accompanying drawings.

A method according to an exemplary embodiment may be performed at a terminal that can access the internet and a social media, by using software for performing the method according to an exemplary embodiment. Accordingly, a terminal installed with the software for processing the method according to the exemplary embodiment may be the terminal according to the exemplary embodiment. For example, the terminal may be not only a portable terminal such as a smartphone, and so on, but also a personal computer, a laptop computer, and so on. Hereinbelow, exemplary embodiments will be described mainly with reference to an example of portable terminal.

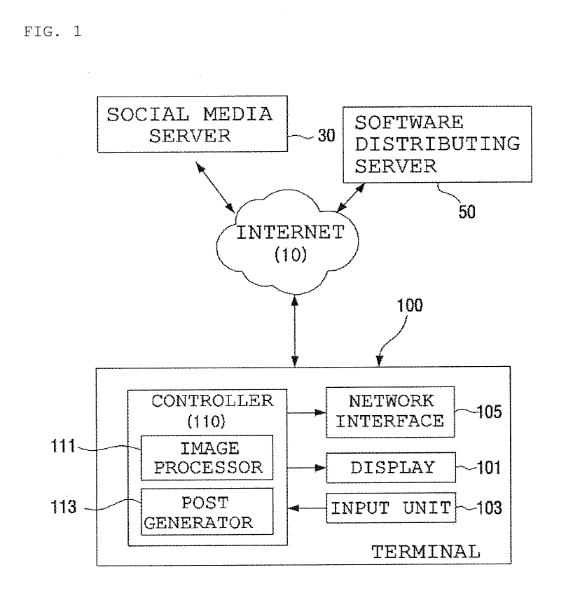

Referring to FIG. 1, the terminal 100 according to an exemplary embodiment may be connected to a social media server 30 (hereinbelow, briefly referred to as ‘media server’) via the internet 10, and may also be connected to a software distributing server 50, and so on. The terminal 100 may provide a User Graphic Interface to the user, through which post to be uploaded on the social media webpage is created, and the user may use the interface to post his or her video on the social media.

In an example, the terminal 100 according to an exemplary embodiment may extract a word from an image content of the user and automatically attach the same as a hash tag to the post. The ‘image content’ as used herein refers to a video, which may include a plurality of image frames, along with audio source, subtitles, and so on. For example, for 60 frame rate, 15-second video, the image content may be formed of 900 image frames, and compressed with Moving Picture Experts Group 4 (MPEG 4).

The media server 30 may be any server, as long as the server runs social media that can allow posts including video to be posted. The currently-widely known social media include Facebook, Instagram, and so on, and for example, the server that runs the Facebook corresponds to the media server 30 according to an exemplary embodiment. The media server 30 is required to not only provide the interface to upload the posts, but also open the Application Programming Interface (API) to notify the name of a person that matches specific data as described below in response to a request from the terminal 100, and API to provide associated search terms for a specific word.

The software distributing server 50 is that server that is generally called ‘App store.’ The image processor 111 and the post generator 113 of the terminal 100, which will be described below, may be composed of at least one software that performs operations thereof, and the terminal 100 may download such software from the software distributing server 50.

In an exemplary embodiment, the terminal 100 is provided with a display 101, an input unit 103, a network interface 105, and a controller 110, and depending on need, may also be provided with a camera (not illustrated) and a microphone (not illustrated) to generate images by itself.

The display 101 is a means to visually display a variety of information to the user, and the input unit 103 receives input such as a control command from the user or messages to be inputted into the post, and so on. The display 101 and the input unit 103 may be integrally formed with each other, like an example of a touch screen. The network interface 105 accesses the media server 30 or the software distributing server 50 via the internet 10.

The controller 110 controls the overall operation of the portable terminal 100, and specifically includes an image processor 111 and a post generator 113 for the purpose of automatic registration of hash tag according to an exemplary embodiment of the present disclosure.

The controller 110 may generally be the configuration already provided in the manufacturing stage of the terminal in order to perform main or basic functions (e.g., phone, wireless networking, displaying etc.) of the portable terminal 100, although it may also be interpreted as a configuration that is specially designed for the purpose of the present disclosure. When the controller 110 is the configuration provided for the purpose of performing basic functions of the portable terminal 100, the controller 110 may be the expression that functionally indicates a configuration of the hardware basically contained in the portable terminal 100, such as, hardware processor chips and operating system (OS) operating based on the hardware processor chips. In other words, even the conventional terminal not applied with the present disclosure may also be provided with the controller 110.

On the above aspect, the image processor 111 and the post generator 113 may be the applications that may be the software that runs on the OS program and that may be provided in the existent terminal for the implementation of the present disclosure. That is, the existent portable terminal provided with the image processor 111 and the post generator 113 may correspond to the portable terminal 100 according to the present disclosure. Meanwhile, the application mentioned above may be software stored on a computer-readable storage medium 51 provided in a separate software distributing server 50, and the portable terminal 100 may access the software distributing server 50 to download the corresponding application (or software) and install the same.

The image processor 111 and the post generator 113 may be set to constantly operate in the portable terminal even when the portable terminal 100 is in locked state, but it is preferable that the image processor 111 and the post generator 113 are operated only when these are unlocked and in response to a separate operation command (e.g., icon click, etc.)

The image processor 111 extracts a word to be used as a hash tag from the image content to be inserted into the user's post, with a method of recognizing an object from a video and a method of extracting a word from a subtitle inserted in the image content.

For the object recognition, the image processor 111 performs image processing to extract an object from the entire frames of the image content. The ‘object’ may be any of human face, telephone, automobile, cup, fruit, and so on, and may also be extracted from one of a plurality of frames of the image content.

For the purpose of object recognition, a known method such as contour detection may be used. For example, for human face, the method recognizes with general ‘facial features’ or minutiae of human face, and determines whether the object displayed in a specific region of the image corresponds to a human face or not. Since objects are extracted from respective image frames, by the image processing technique, the objects repeatedly extracted from the same locations of several image frames undergo a process in which these are determined to be the same object, and the image processor 111 extracts at least one object from the corresponding image content.

When the object is recognized, the image processor 111 extracts a name of at least one recognized object from database. In one example, the database may be provided in the terminal 100, or alternatively, the database may preferably be the media server 30. Specifically, when the extracted object is a human face, the image processor 111 provides the media server 30 with the feature data (or minutiae) and acquires an extracted name of a person. In this example, the media server 30 may open API that provides the name of the person matching the feature data.

Secondly, the image processor 111 extracts at least one noun from the subtitle inserted in the image content. That is, the image processor 111 parses the subtitle data (text) of the image content to extract a noun from the corresponding text. To this purpose, the image processor 111 may be provided with algorithm to extract a noun from text, but alternatively, may provide the text to a separate external server such as the media server 30 to distinguish the noun.

The image processor 111 provides the word extracted from the image content to the post generator 113. The word extracted from the image content includes at least one object name as acquired with the object recognition, and at least one noun acquired with subtitle parsing.

When the image content is uploaded to a specific social media, according to a control command of the user, the post generator 113 generates a post to upload on the corresponding social media. In this example, the post generator 113 displays, through the display 101, a screen for the generation of a post for the notice of the user. When the post generating screen A is displayed, the user may select the image, or the user may previously select the image content and request generating of a post, in which case the post generator 113 may display the post generating screen A on the display 101. In either case, when user selects the image content, the image processor 111 may start extracting a word for using a hash tag from the corresponding image content.

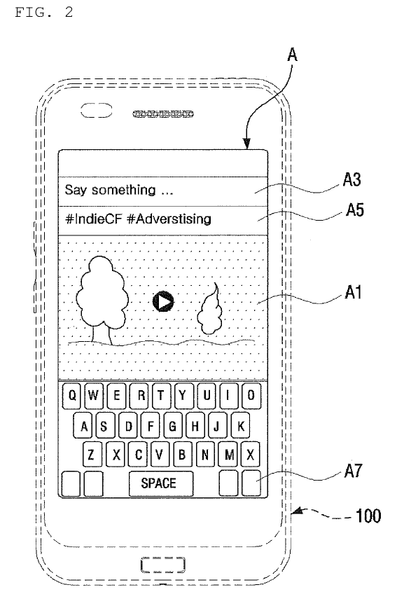

FIG. 2 illustrates an example of the post generating screen A displayed on the display 101. The post generating screen A includes an ‘image region A1’ where the image content is inserted, a ‘message region A3’ where the text message inputted by the user is displayed, and a ‘hash tag region A5’ where a hash tag automatically generated by the post generator 113 (to be described below) or inputted from the user is displayed. The post generating screen A displays an input window A7 to input text into the message region A3 and the hash tag region A5.

The post generator 113 selects a hash tag to be automatically inserted into the post by the user, using the word extracted by the image processor 111 from the image content, and displays the selected hash tag on the hash tag region A5 of the post generating screen A. When the user completes generating a post, the post generator 113 completes generating the post, and uploads the completed post to the social media server 30 using the network interface 105.

<Selecting Hash Tag>

Basically, the post generator 113 attaches all the words extracted from the image content by the image processor 111 as hash tags. When a plurality of words are extracted, the post generator 113 adds ‘#’ in front of each word and then attaches them with spacing to the hash tag region A5.

When too many objects are detected from one image content, or when too many nouns are extracted from the subtitle data, it may be inadequate to set all the names and nouns of the corresponding object as hash tags, or, even impossible due to space limit. In such case, the post generator 113 may select a preset number of names and nouns extracted at the image processor 111 according to a preset priority, and set only the selected ones as hash tags.

### Embodiment 1: Priority by Word Repetition

For example, the possibility is very high that the names and nouns extracted by the image processor 111 may be identical. Accordingly, this priority may basically be set according to an order of higher repetition of the names and nouns extracted by the image processor 111. Accordingly, the post generator 113 may select 5 words that are more repeated among the names and nouns extracted by the image processor 111.

### Embodiment 2: Priority by Person's Name

Meanwhile, considering that the hash tags are used as the indicator with which users collect and search data, the most important factor to consider when determining priority would be the manner in which the general users use the hash tags. It is reported that when users use hash tags to search posts about certain topic or issue, the users often use names of persons, nouns, or the like. Accordingly, when the object is a human face and the image processor 111 detects ‘name of person’ for the name of the object, among all the candidates, this will have to be used as a hash tag.

Accordingly, even when a hash tag is selected according to a certain priority, if the names extracted by the image processor 111 include a name of a person, the priority will have to be ignored and the name of the person will have to be used as the hash tag. Of course, Embodiments 1 and 2 are not exclusive. Accordingly, Embodiments 1 and 2 may be concurrently applied. For example, even when the name of person selected according to Embodiment 2 is not included in the repeated words selected according to Embodiment 1, the post generator 113 may select the hash tags with the name of person and the repeated words as selected in Embodiment 1.

### Embodiment 3: User's Reference Hash Tags

According to some exemplary embodiments, the post generator 113 may receive a reference hash tag from the user. The user may input his or her name, trademark, or any word as the reference hash tag.

Of course, the reference hash tag is displayed on the hash tag region A5 as the hash tag. In addition, upon input of the reference hash tag, the post generator 113 may use preset associated algorithm to extract associated words, and the image processor 111 may set hash tags with at least a word and more that matches the associated words from among the extracted names of the objects and nouns.

For the operation described above, the terminal 100 or the post generator 113 may include associated word extraction algorithm. In another embodiment, the post generator 113 may provide a reference hash tag to an external server (e.g., social media server, etc.) that includes the associated word extraction algorithm, in order to receive the associated words of the reference hash tag. And then the post generator 113 may select, among the names of objects and nouns as extracted by the image processor, a word that matches the associated word as the hash tag.

### Embodiment 4: Reference Hash Tag

In addition to a method of the user directly inputting a reference hash tag as in Embodiment 3, the post generator 113 may select a hash tag from a word from a message inputted by the user on the message region A3 of the post generating screen A.

To achieve this, the post generator 113 may be inputted by a user with a message to be included in the post through the message region A3 of the post generating screen A. Upon input of the message, the post generator 113 may apply the most frequently repeated nouns among at least one noun included in the corresponding message as a reference hash tag.

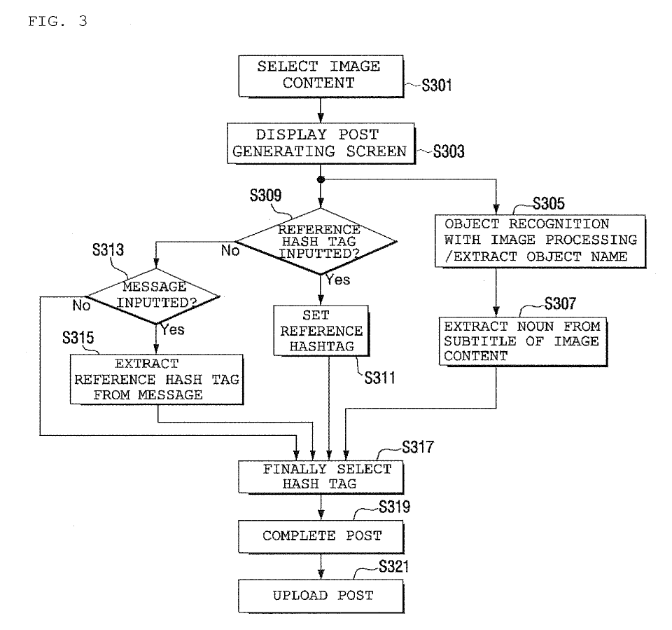

Hereinbelow, a method for attaching hash tag with image recognition according to an exemplary embodiment of the present disclosure will be described with reference to FIG. 3.

<On Generating a New Post: S301, S303>

At S301, the user selects image content and requests a specific media server 30 for the generation of a psot. Accordingly, at S303, the post generator 113 displays the post generating screen A on the display 101.

As described earlier, the user may request the post generating screen A and selects the image content.

<Extracting Word from Image Content: S305, S307>

At S305, the image processor 111 starts image processing to recognize at least one object from the image content and extracts names of the recognized objects, and at S307, extracts at least one noun from subtitle data inserted in the image content. The image processor 111 delivers the extracted name of object and noun to the post generator 113.

<Inputting Reference Hash Tag: S309 to S315>

Meanwhile, along with S305 and S307, at S309, the post generator 113 stands by for an input of a reference hash tag from the user, and at S311, confirms the word as the reference hash tag if the reference hash tag is inputted.

If the reference hash tag is not inputted, at S313, the post generator 113 waits for the input of a message to be inserted into the post by the user through the message region A3, and when the message is inserted, at S315, the post generator 113 selects words used as hash tags from the message with the method of Embodiment 4 described above.

<Setting Hash Tag: S317>

Using the word extracted in S305 and S307, and the reference hash tag selected in S311 or S315, the post generator 113 finally selects at least one hash tag to be inserted into the post. At this time, the post generator 113 may use at least one of the methods selected from Embodiments 1 to 4 described above.

If the reference hash tag is not inputted and no message is inputted either, the post generator 113 uses only the words extracted in S305 and S307 to select the hash tag with the methods of Embodiment 1 and/or Embodiment 2.

<Completing Post and Uploading: S319, S321>

After the words finally selected in S317 are inputted as hash tags, at S319, the post generator 113 waits for the upload command from the user, and at S321, uploads the corresponding post to the media server 30. On the example of FIG. 2, the post generator 113 set automatically 2 words, ‘IndeieCF’ and ‘Advertising’, as hash tags for the new post and displays 2 hash tags with ‘#’ and separating by spaces.

With the method described above, a method for attaching hash tag with the image recognition is performed according to the present disclosure.

The foregoing exemplary embodiments and advantages are merely exemplary and are not to be construed as limiting the exemplary embodiments. The present teaching can be readily applied to other types of apparatuses. Also, the description of the exemplary embodiments of the present inventive concept is intended to be illustrative, and not to limit the scope of the claims.

What is claimed is:

1. A method for attaching a hash tag, at a terminal capable of generating a post to post a video on a website of a social media, the method comprising:
at a post generator, displaying a post generating screen to generate the post for the video;
at an image processor, recognizing at least one object from each of image frames of the video inserted into the post generating screen, and extracting names of the objects from database;
at the image processor, extracting at least one noun from subtitles inserted into the video; and
at the post generator, inserting the name of at least one object and the at least one noun as hash tags and complete the post.

2. The method of claim 1, further comprising:
at the post generator, inputting a reference hash tag from a user; and
at the post generator, using a preset associated algorithm to select at least one word associated with the reference hash tag from among the name of at least one object and the at least one noun,
wherein the completing the post comprises attaching the selected word as the hash tag, instead of the name of at least one object and the at least one noun.

3. The method of claim 2, wherein the inputting the reference hash tag comprises:
inputting, through the post generating screen and from the user, a message to be included in the post; and
applying a noun that is most frequently repeated among the at least one noun included in the message, as the reference hash tag.

4. The method of claim 1, further comprising, at the post generator, selecting, among the name of at least one object and the at least one noun, a preset number of words in an order of higher rate of repetition,
wherein the completing the post comprises attaching the selected words as the hash tag.

5. The method of claim 4, wherein, when the extracted object is a face of a person, the completing the post comprises attaching a name of the person extracted from the database, along with the selected words, and
the database is a server of the social media website.

6. The method of claim 1, wherein, when the extracted object is a face of a person, the database is a server of the social media website.

7. A software distributing server comprising a computer-readable storage medium storing therein software to perform an operation of the image processor and the post generator with the method for setting hash tags according to claim 1, and enabling the terminal accessing via the internet to download the software.
